(19) United States
(12) Patent Application Publication
(10) Pub. No.: US 2025/0386155 A1
(43) Pub. Date: Dec. 18, 2025

(54) EAR-WEARABLE ELECTRONIC DEVICE

(71) Applicant: STARKEY LABORATORIES, INC., Eden Prairie, MN (US)

(72) Inventors: Ganesh Borra, Minneapolis, MN (US); Mark Pankratz, Bloomington, MN (US)

(21) Appl. No.: 19/235,915

(22) Filed: Jun. 12, 2025

Related U.S. Application Data
(60) Provisional application No. 63/660,836, filed on Jun. 17, 2024.

(51) Int. Cl. H04R 25/00; H04R 1/10

(52) U.S. Cl. CPC H04R 25/609; H04R 1/1016; H04R 1/1025; H04R 1/1075; H04R 25/602; H04R 25/65; H04R 2201/003; H04R 2225/025; H04R 2225/31; H04R 2225/51

(57) ABSTRACT

Various embodiments of an ear-wearable electronic device are disclosed. The device includes a shell having a first end configured to be disposed in an ear canal of the wearer and a second end configured to be disposed proximate to a concha of the ear of the wearer. The device further includes an electro-mechanical package that includes a faceplate connected to the shell to form an enclosure, and a flexible printed circuit board assembly (PCBA) disposed within the enclosure proximate to the second end of the shell and supported by at least one of an exterior surface of a battery housing or the faceplate. The package further includes a micro-mechanical systems (MEMS) receiver disposed proximate to the second end of the shell and surface mounted to the PCBA, and an acoustic port that is acoustically coupled to the receiver.

### CROSS-REFERENCE TO RELATED APPLICATION

This application claims the benefit of U.S. Provisional Application No. 63/660,836, filed Jun. 17, 2024, the disclosure of which is incorporated by reference herein in its entirety.

### BACKGROUND

Ear-wearable electronic devices such as hearing devices are disposed in an ear of a wearer or inserted into an opening of an ear canal of the wearer and typically include a housing or shell with electronic components such as a receiver (i.e., speaker) disposed within the housing. The receiver is adapted to provide acoustic information in the form of acoustic waves to the wearer's ear canal from a controller either disposed within the housing of the hearing device or connected to the hearing device by a wired or wireless connection. This acoustic information can include music or speech from a recording or other source, e.g., ambient sounds such as speech from a person or persons that are speaking in proximity to the wearer. Such speech can be amplified so that the wearer can better hear the speaker.

Hearing assistance devices, such as hearing aids, can be used to assist wearers suffering hearing loss by amplifying sounds into one or both ear canals. Such devices typically include hearing assistance components such as a microphone for receiving ambient sound, an amplifier for amplifying the microphone signal in a manner that depends upon the frequency and amplitude of the microphone signal, a speaker or receiver for converting the amplified microphone signal to sound for the wearer, and a battery for powering the components.

### SUMMARY

In general, the present disclosure provides various embodiments of an ear-wearable electronic device that includes an electro-mechanical package connected to a shell that has a first end configured to be disposed in an ear canal of a wearer and a second end configured to be disposed proximate to a concha of the ear. The package includes a faceplate and a flexible printed circuit board assembly (PCBA) disposed within an enclosure formed by the faceplate and the shell. One or more micro-mechanical systems (MEMS) receivers can be disposed proximate to the second end of the shell and surface mounted to the PCBA. An acoustic port is disposed at least partially within the enclosure and includes an inlet that is acoustically coupled to the MEMS receiver and an outlet that is disposed at the first end of the shell. In one or more embodiments, the shell further includes a first portion adjacent the first end of the shell and a second portion adjacent the second end of the shell, where the receiver is disposed in the second portion. Further, in one or more embodiments, a maximum cross-sectional area of the second portion is greater than a maximum cross-sectional area of the first portion.

In one aspect, the present disclosure provides an ear-wearable electronic device including a shell having an outer surface that corresponds to an ear geometry of an ear of a wearer of the device. The shell includes a first end configured to be disposed in an ear canal of the wearer and a second end configured to be disposed proximate to a concha of the ear of the wearer, where the second end includes a first contact surface. The device further includes an electro-mechanical package connected to the shell. The package includes a faceplate having an outer surface and an inner surface, where the inner surface includes a second contact surface configured to engage the first contact surface of the second end of the shell to form an enclosure with the shell; a battery housing including a battery compartment configured to receive a battery, where the battery housing is configured to be connected to the inner surface of the faceplate; and a flexible printed circuit board assembly (PCBA) disposed within the enclosure proximate to the second end of the shell and supported by at least one of an exterior surface of the battery housing or the faceplate. The package further includes a micro-mechanical systems (MEMS) receiver disposed proximate to the second end of the shell and surface mounted to the PCBA. The device further includes an acoustic port disposed at least partially within the enclosure and extending between an inlet that is acoustically coupled to the receiver and an outlet that is disposed at the first end of the shell.

In another aspect, the present disclosure provides an electro-mechanical package for an ear-wearable electronic device, including a faceplate having an outer surface, an inner surface, and a second contact surface configured to engage a first contact surface of a shell to form an enclosure of the hearing device; a battery housing including a battery compartment configured to receive a battery, where the battery housing is configured to be connected to the inner surface of the faceplate; and a flexible printed circuit board assembly (PCBA) supported by at least one of an exterior surface of the battery housing or the faceplate. The package also includes a micro-mechanical systems (MEMS) receiver surface mounted to the PCBA.

In another aspect, the present disclosure provides a method including forming an electro-mechanical package, where forming the package includes connecting a battery housing to a faceplate, where the battery housing has a battery compartment configured to receive a battery; disposing a flexible printed circuit board assembly (PCBA) on at least one of an exterior surface of the battery housing or the faceplate; and surface mounting a micro-mechanical systems (MEMS) receiver to the PCBA. The method further includes connecting the faceplate to a second end of a shell that is configured to be disposed proximate to a concha of the ear of a wearer, where the shell and the faceplate form an enclosure within which the receiver and the PCBA are disposed, where the receiver is disposed proximate to the second end of the shell; and acoustically coupling the receiver to an inlet of an acoustic port that is disposed at least partially within the enclosure and extends between the inlet and an outlet that is disposed at a first end of the shell that is configured to be disposed in an ear canal of the wearer.

All headings provided herein are for the convenience of the reader and should not be used to limit the meaning of any text that follows the heading, unless so specified.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements. The term “consisting of” means “including,” and is limited to whatever follows the phrase “consisting of.” Thus, the phrase “consisting of” indicates that the listed elements are required or mandatory and that no other elements may be present. The term “consisting essentially of” means including any elements listed after the phrase and is limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The words “preferred” and “preferably” refer to embodiments of the disclosure that may afford certain benefits, under certain circumstances; however, other embodiments may also be preferred, under the same or other circumstances. Furthermore, the recitation of one or more preferred embodiments does not imply that other embodiments are not useful and is not intended to exclude other embodiments from the scope of the disclosure.

In this application, terms such as “a,” “an,” and “the” are not intended to refer to only a singular entity but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

These and other aspects of the present disclosure will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1 is a schematic perspective view of one embodiment of an ear-wearable electronic device.

FIG. 2 is a schematic side view of the ear-wearable electronic device of FIG. 1.

FIG. 3 is a schematic rear perspective exploded view of the ear-wearable electronic device of FIG. 1.

FIG. 4 is a schematic front perspective exploded view of the ear-wearable electronic device of FIG. 1.

FIG. 5 is a schematic side view of the ear-wearable electronic device of FIG. 1 disposed at least partially within an ear of a wearer.

FIG. 6 is a schematic side view of an electro-mechanical package of the ear-wearable electronic device of FIG. 1.

FIG. 7 is a schematic perspective view of the ear-wearable electronic device with a shell of the device made transparent for explanatory purposes.

FIG. 8 is a schematic side cross-section view of the ear-wearable electronic device of FIG. 1.

FIG. 9 is a schematic side view of the ear-wearable electronic device of FIG. 1 disposed at least partially within an ear canal of the ear of the wearer.

FIG. 10 is a schematic perspective view of another embodiment of an electro-mechanical package that can be utilized with the ear-wearable electronic device of FIG. 1.

FIG. 11 is a schematic diagram of another embodiment of an ear-wearable electronic device.

FIG. 12 is a flowchart of a method of manufacturing the ear-wearable electronic device of FIG. 1.

### DETAILED DESCRIPTION

In general, the present disclosure provides various embodiments of an ear-wearable electronic device that includes an electro-mechanical package connected to a shell that has a first end configured to be disposed in an ear canal of a wearer and a second end configured to be disposed proximate to a concha of the ear. The package includes a faceplate and a flexible printed circuit board assembly (PCBA) disposed within an enclosure formed by the faceplate and the shell. One or more micro-mechanical systems (MEMS) receivers can be disposed proximate to the second end of the shell and surface mounted to the PCBA. An acoustic port is disposed at least partially within the enclosure and includes an inlet that is acoustically coupled to the MEMS receiver and an outlet that is disposed at the first end of the shell. In one or more embodiments, the shell further includes a first portion adjacent the first end of the shell and a second portion adjacent the second end of the shell, where the receiver is disposed in the second portion. Further, in one or more embodiments, a maximum cross-sectional area of the second portion is greater than a maximum cross-sectional area of the first portion.

Ear-wearable electronic devices such as custom hearing assistance devices typically provide a better fit for the wearer when an overall size of the device is reduced. Various clinical studies have found that ear canal cross-sections range from 3 mm to 12 mm. For narrower ear canals, custom hearing assistance devices may not fit comfortably within the canal as they typically have a wired receiver (i.e., speaker) positioned within the ear canal where the canal narrows adjacent the ear drum. Further, a conventional completely-in-canal hearing device that includes a standard receiver that is wired to a main circuit requires that a posterior portion of the hearing device be at least 5 mm in width and height to accommodate the receiver.

One or more embodiments of an ear-wearable electronic device described herein can provide various advantages over these currently-available devices. For example, one or more embodiments of an ear-wearable electronic device can include an electro-mechanical package that includes one or more receivers that can be electrically connected to a PCBA using surface-mounted-device (SMD) reflow processes such that the receiver is disposed on or at least partially within the PCBA. The receiver can be disposed in an anterior portion of the device to allow the posterior portion of the device to be narrower, thereby improving a fit rate for narrow ear canals. Further, replacing the wired receiver with an SMD receiver that is disposed on the PCBA can eliminate wires and manual operation steps required to connect receiver pads to main circuit pads through extra set of wires. Such SMD processes can eliminate solder pads and reposition the receiver closer to a faceplate that is connected to the anterior portion of the device in contrast to the typical location of the receiver in the posterior portion. Positioning the receiver in the anterior portion of the device can also allow two or more receivers to be disposed within the device without increasing the size of the overall device, thereby providing additional sound quality features that may not be available through the use of a single receiver.

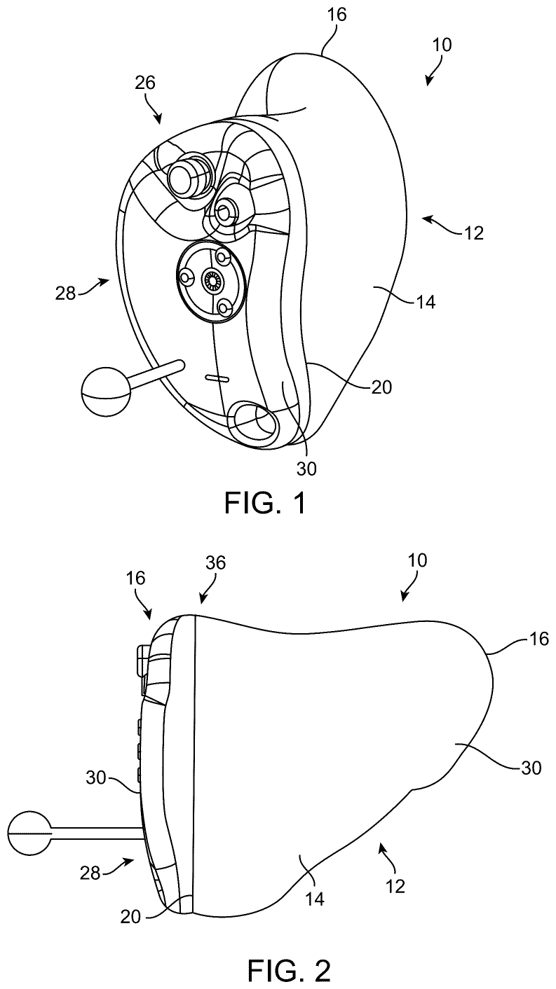

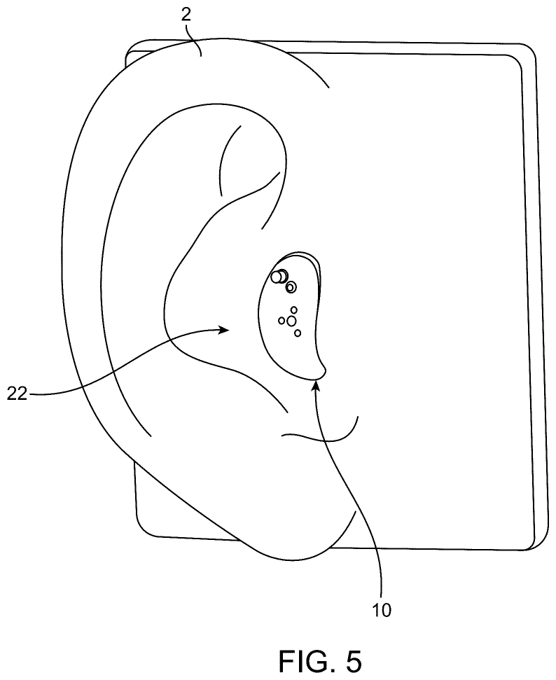

FIGS. 1-9 are various views of one embodiment of an ear-wearable electronic device 10. The device 10 can represent a variety of different custom hearing devices and can be configured as an in-the-ear (ITE), in-the-canal (ITC), completely-in-canal (CIC) or invisible-in-canal (IIC) type device, for example. The device 10 includes a shell 12, which, in one or more embodiments, can have a uniquely shaped outer surface 14 that corresponds uniquely to an ear geometry of a wearer of the device. For example, the shell 12 can be developed based on a mold taken from the wearer's ear 2 (FIG. 5). As such, one or more embodiments of the device 10 can be considered a custom ear-wearable electronic device. The shell 12 is configured to be disposed at least partially within an ear canal 18 (FIG. 9) of the ear 2 of the wearer.

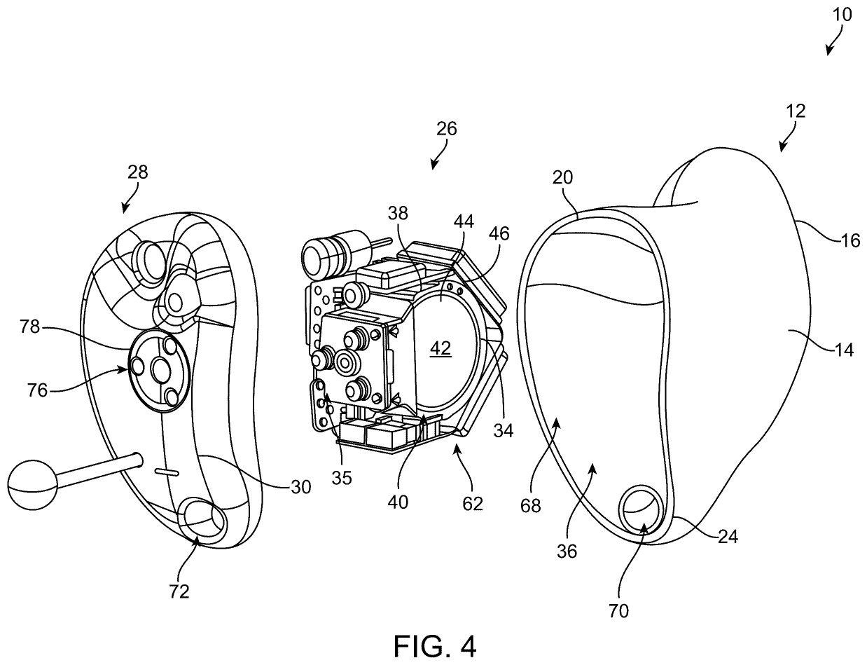

The shell 12 includes a first end 16 configured to be disposed in the ear canal 18 of the wearer and a second end 20 configured to be disposed proximate to a concha 22 (FIG. 5) of the ear 2 of the wearer. The second end 20 of the shell 12 includes a first contact surface 24 (FIG. 4).

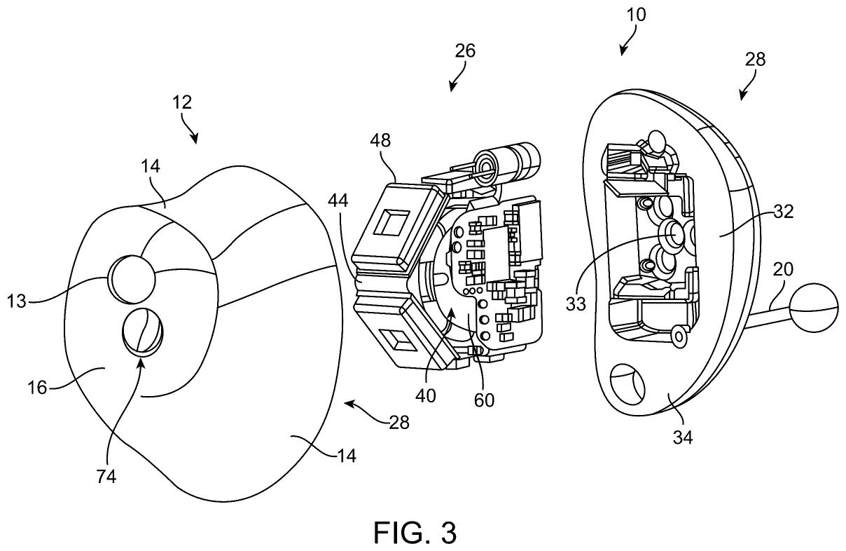

The device 10 further includes an electromechanical package 26 (FIGS. 3-4) connected to the shell 12. The package 26 includes a faceplate 28, which is shown connected to the shell 12 in FIGS. 1 and 2. The faceplate 28 includes an outer surface 30 and an inner surface 32. The inner surface 32 includes a second contact surface 34 (FIG. 3) configured to engage the first contact surface 24 of the second end 20 of the shell 12 to form an enclosure 36 with the shell.

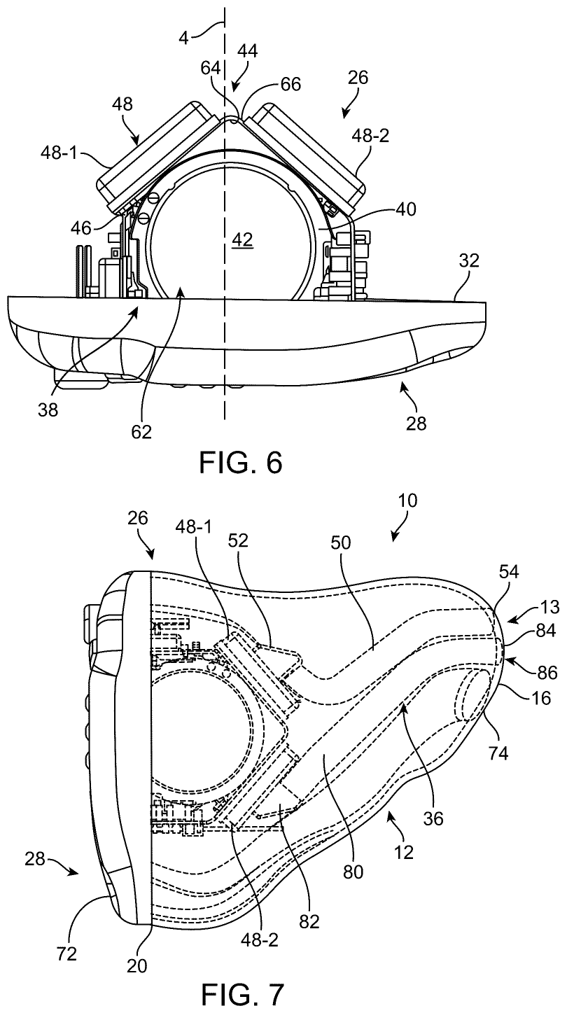

The electromechanical package 26 further includes a battery housing 38 (FIG. 6) that includes a battery compartment 40 configured to receive a battery 42. The battery housing 38 is configured to be connected to the inner surface 32 of the faceplate 28. The package 26 also includes a flexible printed circuit board assembly (PCBA) 44 disposed within the enclosure 36 proximate to the second end 20 of the shell 12 and supported by at least one of an exterior surface 46 of the battery housing 38 or the faceplate 28. One or more micro-mechanical systems (MEMS) receivers 48 of the package 26 are disposed proximate to the second end 20 of the shell 12 and surface mounted to the PCBA 44. Further, the ear-wearable electronic device 10 also includes an acoustic port 50 (FIG. 7) disposed at least partially within the enclosure 36 and extending between an inlet 52 that is acoustically coupled to the receiver 48 and an outlet 54 that is disposed at the first end 16 of the shell 12.

The shell 12 can, in one or more embodiments, have a uniquely shaped outer surface 14 that corresponds uniquely to an ear geometry of the wearer of the device 10. The shell 12 can include any suitable materials, e.g., at least one of an inorganic (e.g., metallic, ceramic) or organic (e.g., polymeric) material. The shell 12 can be manufactured using any suitable technique, e.g., molding, injection molding, 3D printing, etc.

The shell 12 can also have any suitable dimensions. As shown schematically in FIG. 9, the shell 12 includes a first portion (i.e., posterior portion) 56 and a second portion (i.e., anterior portion) 58. The first portion 56 is adjacent the first end 16 of the shell 12 and the second portion 58 is adjacent the second end 20 of the shell. As is further described herein, in one or more embodiments, at least the receiver 48 is disposed in the second portion 58.

The first and second portions 56, 58 can each have any suitable cross-sectional area in a plane orthogonal to a longitudinal axis 4 of the device 10 (FIGS. 6 and 8-9). The longitudinal axis 4 is defined as an axis that is substantially perpendicular to the inner surface 32 of the faceplate 28 at a center point 33 (FIG. 3) of the inner surface, where the center point is a geometrical center of the inner surface 32 of the faceplate 28. In one or more embodiments, the second portion 58 has a maximum cross-sectional area that is greater than a maximum cross-sectional area of the first portion 56. The cross-sectional area of the first portion 56 can be constant along the longitudinal axis 4 or vary along the longitudinal axis. Further, the cross-sectional area of the second portion 58 can be constant along the longitudinal axis 4 or vary along the longitudinal axis.

Connected to the shell 12 is the electro-mechanical package 26. The package 26 includes the faceplate 28. The inner surface 32 of the faceplate 28 includes the second contact surface 34 having a predefined configuration that can be standardized across the same family or families of the devices 10. The second contact surface 34 extends along a periphery of the inner surface 32 of the faceplate 28 and has a generally flat shape. More particularly, the second contact surface 34 of the faceplate 28 has a shape and size configured to matingly engage the first contact surface 24 of the shell 12. In one or more embodiments, the second contact surface 34 of the faceplate 28 is configured to interlockingly engage with the first contact surface 24 of the second end 20 of the shell 12. Standardization of the first contact surface 24 of the shell 12 and the second contact surface 34 of the faceplate 28 can significantly reduce the manufacturing complexity and cost of fabricating a custom ear-wearable electronic device, while providing for a custom-shaped shell unique to the ear geometry of a particular wearer of the device 10.

The faceplate 28 can take any suitable shape and have any suitable dimensions. Further, the faceplate 28 can include any suitable materials, e.g., at least one of an inorganic (e.g., metallic, ceramic) or polymeric material. In one or more embodiments, the faceplate 28 includes a nylon-based polyamide thermoplastic material. The faceplate 28 can be manufactured using any suitable technique, e.g., molding, injection molding, 3D printing, etc.

As shown in FIG. 6, the electro-mechanical package 26 further includes the battery housing 38. The battery housing 38 includes the battery compartment 40 that is configured to receive the battery 42, such as a lithium-ion rechargeable battery. As shown, the battery compartment 40 and the battery housing 38 have a shape that conforms to the shape of the battery 42. More particularly, the battery 42, battery housing 38, and battery compartment 40 are shown to have a generally cylindrical shape. It is noted that, in some implementations, the battery 42 can have a polygonal shape (e.g., rectangle, square), and the battery housing 38 and battery compartment 40 can conform to the shape of the polygonal battery; however, a cylindrical battery, battery housing, and battery compartment may be preferred for enhancing packaging efficiency. The battery housing 38 and battery compartment 40 can include any suitable material, e.g., a polymeric material. Further, the battery housing 38 can include a mounting interface 35 (FIG. 4) that is configured to be connected to the inner surface 32 of the faceplate 28 using any suitable technique, e.g., one or more of the techniques described in in U.S. Patent Publication No. 2023/0336928 A1, entitled COMPACT ELECTRO-MECHANICAL PACKAGING FOR A CUSTOM HEARING DEVICE.

The battery compartment 40 includes a closed end 60 (FIG. 3) and an opposing open end 62 (FIG. 6). The open end 62 is dimensioned to receive the battery 42. The open end 62 can be configured to receive a cap (not shown) that is configured to seal the battery 42 within the battery compartment 40. The cap can be snapped into place to seal the battery 42 within the battery compartment 40.

In one or more embodiments, the battery compartment 40 has a short dimension and a long dimension depending on the shape of the battery 42. In such embodiments, the faceplate 28, which can have a generally flat inner surface 32 and curved outer surface 30, can be oriented orthogonal to the long dimension of the battery compartment 40. For example, the battery 42 can have a cylindrical shape with two opposing flat sides. The battery compartment 40 can be configured such that the flat sides of the battery 42 are oriented orthogonal to the outer surface of the faceplate 28. This orientation of the battery 42 relative to the faceplate 28 provides for a tighter and smaller packaging fit for the battery and battery housing 38.

The battery housing 38 includes an exterior surface 46 that can support the flexible PCBA 44. In one or more embodiments, the PCBA 44 (FIG. 6) can be supported by the faceplate 28. In one or more embodiments, the PCBA 44 can be supported by one or both of the exterior surface 46 of the battery housing 38 and the faceplate 28. It is understood that the flexible PCBA 44 is a laminated, flexible sandwich structure that can include conductive layers, insulating layers, and vias allowing for interconnections between layers. The PCBA 44 can support and/or be coupled to various electronic components (e.g., integrated circuits, processors, memories), electrical circuitry (passive and active electrical components), one or more sensors, and/or one or more transducers (e.g., a microphone, a receiver, etc.).

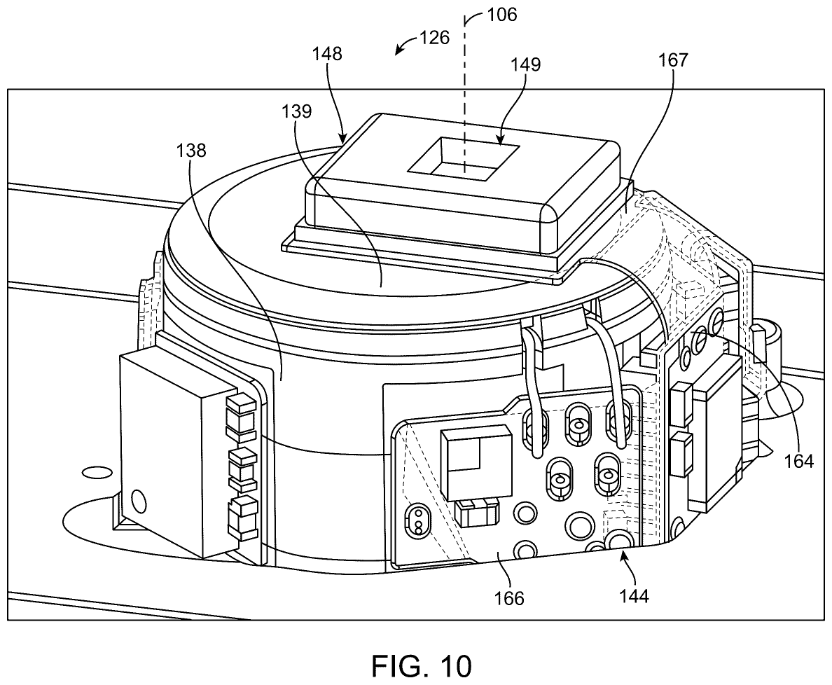

The PCBA 44 has a first surface 64 (FIG. 6) that is configured to face the battery housing 38. The first surface 64 of the PCBA 44 can cover some or all of the battery housing 38. The PCBA 44 can include a second surface 66 that is configured to face an inner surface 68 (FIG. 4) of the shell 12. As shown in FIG. 6, the second surface 66 of the PCBA 44 wraps around the battery housing 38. The second surface 66 of the PCBA 44 can be configured to support one or more electronic components, e.g., the one or more MEMS receivers 48. In one or more embodiments, the first surface 64 can also be configured to support one or more electronic components. Although illustrated as including first and second surfaces 64, 66, the PCBA 44 can include one or more additional surfaces that connect to at least one of the first or second surfaces and can extend over at least one of the battery compartment 40, the battery 42, or the inner surface 32 of the faceplate 28 (e.g., third surface 167 of PCBA 144 of electro-mechanical package 126 illustrated in FIG. 10).

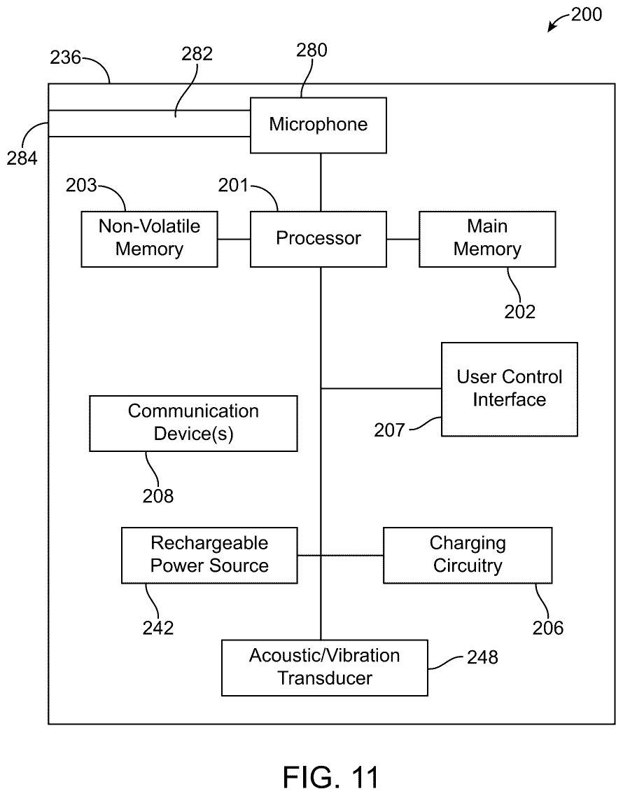

In general, the device 10 can include any suitable electronic circuitry and components disposed on or within the device, e.g., one or more of the electronic circuitry and components described herein regarding ear-wearable electronic device 200 of FIG. 11. For example, surface mounted to the PCBA 44 is one or more MEMS receivers 48. The device 10 can include any suitable number of MEMS receivers 48 disposed on the PCBA 44 or elsewhere within the enclosure 36. In the embodiment illustrated in FIGS. 1-9, the device 10 includes a first MEMS receiver 48-1 and a second MEMS receiver 48-2 (collectively referred to herein as MEMS receiver or receivers 48). The MEMS receivers 48 can include any suitable MEMS receiver or speaker.

Further, the MEMS receivers 48 can be disposed on the PCBA 44 using any suitable technique, e.g., surface mounting. The MEMS receiver 48 can be disposed on or at least partially within any suitable portion of the PCBA 44. In one or more embodiments, one or more MEMS receivers 48 can be disposed on at least one of the inner surface 32 of the faceplate 28 or on the inner surface 68 of the shell 12, and electrically connected to one or more devices disposed within the enclosure 36 (e.g., on or at least partially within the PCBA 44) using any suitable technique.

For example, FIG. 10 is a schematic perspective view of a portion of another embodiment of an electro-mechanical package 126. All design considerations and possibilities described herein regarding electro-mechanical package 26 of FIGS. 1-9 apply equally to package 126 of FIG. 10 to the extent that they do not conflict. The package 126 can be utilized with any suitable ear-wearable electronic device, e.g., ear-wearable electronic device 10 of FIGS. 1-9.

One difference between package 126 and package 26 is that package 126 includes a PCBA 144 having a first surface 164, a second surface 166, and a third surface 167 that is connected to the first and second surfaces. The third surface 167 extends over a side surface 139 of battery housing 138. In one or more embodiments, the third surface 167 can extend over an open end (not shown) of the battery housing 138 such that the third surface extends across at least one opposing flat side of the battery (not shown).

Another difference between package 126 and package 26 is that a MEMS receiver 148 can be disposed on or at least partially within the third surface 167 of the PCBA 144 such that a normal 106 to an outlet 149 of the receiver is substantially orthogonal to flat sides of the battery or the side surface 13 of the battery housing 138.

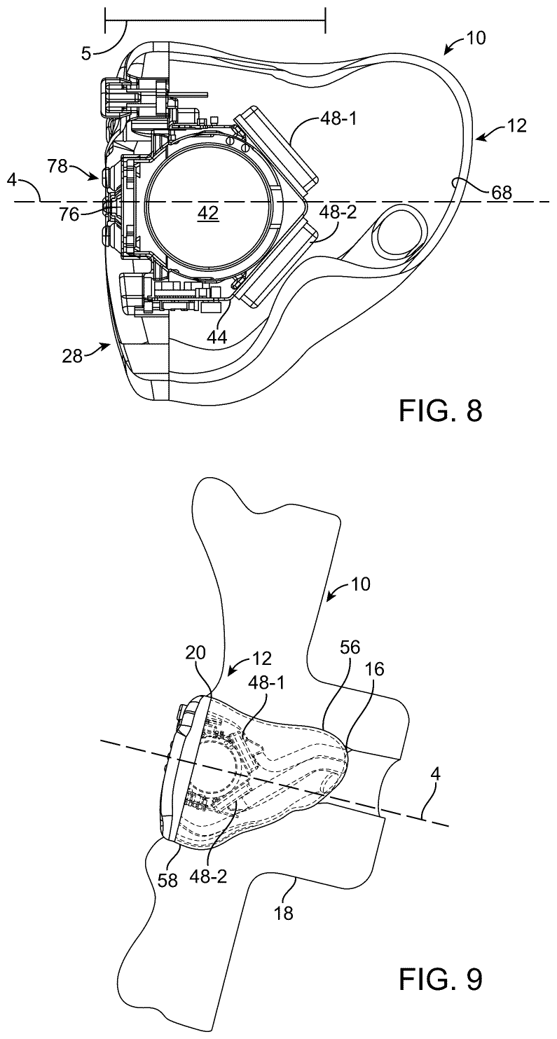

Returning to FIGS. 1-9, each of the MEMS receivers 48 can be disposed in any suitable location within the enclosure 36. As shown, the MEMS receivers 48 are disposed proximate to the second end 20 of the shell 12. Further, as shown in FIG. 9, the MEMS receivers 48 are disposed within the enclosure 36 such that they are proximate to the concha 22 when the device is disposed within the ear canal 18. In one or more embodiments, the MEMS receivers 48 are disposed within the enclosure 36 within a distance 5 (FIG. 8) of about 10 mm from the inner surface 32 of the faceplate 28 as measured along the longitudinal axis 4. In other words, in such embodiments, no portion of any of the one or more MEMS receivers 48 (not including the acoustic port 50 and the inlet 52 of the port) is disposed beyond 10 mm from the inner surface 32 of the faceplate 28 as measured along the longitudinal axis 4. In one or more embodiments, the MEMS receivers 48 are disposed within a distance 5 of about 8 mm from the inner surface 32 of the faceplate 28 as measured along the longitudinal axis 4. In one or more embodiments, the MEMS receivers 48 are disposed within a distance 5 of about 6 mm from the inner surface 32 of the faceplate 28 as measured along the longitudinal axis 4.

Acoustic waves from the MEMS receivers 48 can be directed to the ear canal 18 or can propagate into the ear canal of the wearer using any suitable technique. For example, the acoustic port 50 can be disposed at least partially within the enclosure 36 and extend between the inlet 52 that is acoustically coupled to the first MEMS receiver 48-1 and the outlet 54 that is disposed at the first end 16 of the shell 12 (FIG. 7). The acoustic port 50 can include any suitable material and take any suitable shape. Further, the acoustic port 50 can have any suitable dimensions. In one or more embodiments, the acoustic port 50 can be a separate tube or conduit that is disposed at least partially within the shell 12. In one or more embodiments, the acoustic port 50 can be a channel that is disposed or formed in the shell 12.

The inlet 52 of the acoustic port 50 can be acoustically coupled to the first MEMS receiver 48-1 using any suitable technique. Further, the outlet 54 of the acoustic port 50 can extend through an opening 13 disposed in the first end 16 of the shell 12 or be acoustically coupled to the opening without extending through the first end of the shell.

Each MEMS receiver 48 can be acoustically coupled to an acoustic port such as acoustic port 50. For example, as shown in FIG. 7, the second MEMS receiver 48-2 can also be acoustically coupled to an acoustic port 80 that extends between an inlet 82 coupled to the second receiver and an outlet 84 that is disposed at the first end 16 of the shell 12. In such embodiments, the acoustic port 50 can be referred to as the first acoustic port, and the acoustic port 80 can be referred to as the second acoustic port. In one or more embodiments, the outlet 84 of such second acoustic port 80 can be acoustically coupled to the acoustic port 50 (i.e., the first acoustic port) such that acoustic waves from each of the MEMS receivers 48 are directed or propagate through the outlet 54 of the first acoustic port 50 and beyond the first end 16 of the shell 12 into the ear canal 18 of the wearer. In one or more embodiments, the outlet 84 of the second acoustic port 80 can be disposed at the first end 16 of the shell 12 either at the opening 13 of the shell or at a second opening 86 of the shell. The second acoustic port 80 can include any suitable acoustic port, e.g., acoustic port 50.

The ear-wearable electronic hearing device 10 can further include any suitable additional elements or components. For example, as shown in FIGS. 3-4 and 7, the device 10 can further include a vent 70 that extends between a first port 72 disposed in the faceplate 28 and a second port 74 disposed at the first end 16 of the shell 12. The vent 70 can provide ambient acoustic waves from the wearer's environment to the ear canal 18. In one or more embodiments, one or more valves can be coupled to or disposed within the vent 70 to control the amount of ambient acoustic waves that are provided to the ear canal 18.

The device 10 can also include one or more magnets 76 disposed on or at least partially within the faceplate 28 (FIG. 4). The magnet 76 can be utilized to retain the device 10 in a charging base or case such that electrical energy can be directed from the charging base to electrical contacts 78 that are electrically connected to the battery 42. In some currently-available devices, magnetic fields generated by the magnet 76 may interfere with operation of the receiver disposed within the device. The MEMS receivers 48 of the present device 10 are not susceptible to such magnetic fields. As a result, the MEMS receivers 48 can be disposed closer to the faceplate 28 and the magnet 76 as compared to typical receivers, thereby providing a smaller profile of the first portion 56 of the device that is disposed at least partially within the ear canal 18.

The various embodiments of ear-wearable devices described herein can include any suitable electronic components or circuitry. For example, FIG. 11 is a block diagram that illustrates one embodiment of a system and ear-wearable electronic device 200 in accordance with any of the embodiments disclosed herein. The device 200 includes an enclosure 236 configured to be worn in, on, or about an ear of a wearer. The device 200 shown in FIG. 11 can represent a single device configured for monaural or single-ear operation or one of a pair of hearing devices configured for binaural or dual-ear operation. Various components are situated or supported within or on the enclosure 236. The enclosure 236 can be configured for deployment on a wearer's ear (e.g., a behind-the-ear device housing), within an ear canal of the wearer's ear (e.g., an in-the-ear, in-the-canal, invisible-in-canal, or completely-in-the-canal device housing) or both on and in a wearer's ear (e.g., a receiver-in-canal or receiver-in-the-ear device housing).

The device 200 includes a processor 201 operatively coupled to a main memory 202 and a non-volatile memory 203. The processor 201 can be implemented as one or more of a multi-core processor, a digital signal processor (DSP), a microprocessor, a programmable controller, a general-purpose computer, a special-purpose computer, a hardware controller, a software controller, a combined hardware and software device, such as a programmable logic controller, and a programmable logic device (e.g., FPGA, ASIC). The processor 201 can include or be operatively coupled to main memory 202, such as RAM (e.g., DRAM, SRAM). The processor 201 can include or be operatively coupled to non-volatile (persistent) memory 203, such as ROM, EPROM, EEPROM or flash memory.

The device 200 includes an audio processing facility operably coupled to, or incorporating, the processor 201. The audio processing facility includes audio signal processing circuitry (e.g., analog front-end, analog-to-digital converter, digital-to-analog converter, DSP, and various analog and digital filters), a microphone arrangement 280, and an acoustic/vibration transducer 248 (e.g., loudspeaker, receiver, bone conduction transducer, motor actuator). In one or more embodiments, the transducer 248 is one or more MEMS receivers (e.g., MEMS receivers 48 of FIGS. 1-9). Each of the microphone arrangement 280 and transducer 248 can be disposed on or at least partially within a PCBA (e.g., PCBA 44) disposed within the enclosure 236. The acoustic transducer 248 produces amplified sound inside the ear canal.

The microphone arrangement 280 can include one or more discrete microphones or a microphone array(s) (e.g., configured for microphone array beamforming). Each of the microphones of the microphone arrangement 280 can be situated at different locations of the enclosure 236. It is understood that the term microphone used herein can refer to a single microphone or multiple microphones unless specified otherwise. The microphone 280 is operatively coupled to the processor 201 and is configured to direct a microphone signal to the processor, which in turn directs a receiver signal to the transducer 248 that is based at least in part on the microphone signal.

At least one of the microphones 280 may be configured as a reference microphone that produces a reference signal in response to external sound outside an ear canal of a user. Generally, at least one of the reference microphones 280 (also referred to as an externally facing microphone) is acoustically coupled to ambient air outside the enclosure 236 via an acoustic pathway or acoustic port 282 and a microphone inlet 284. The microphone inlet 284 allows air to pass between two parts of the enclosure 236 or may be formed within one part of the enclosure. In one or more embodiments, the microphone inlet 284 is disposed in a faceplate (e.g., faceplate 28) of the device 200.

The device 200 may also include a user control interface 207 operatively coupled to the processor 201. The user control interface 207 is configured to receive an input from the wearer of the device 200. The input from the wearer can be any type of user input, such as a touch input, a gesture input, or a voice input. The user control interface 207 may be configured to receive an input from the wearer of the device 200.

The device 200 can include one or more communication devices 208. For example, the one or more communication devices 208 can include one or more radios coupled to one or more antenna arrangements that conform to an IEEE 802.13 (e.g., Wi-Fi®) or Bluetooth® (e.g., BLE, Bluetooth® 4.2, 5.0, 5.1, 5.2 or later) specification, for example. In addition, or alternatively, the device 200 can include a near-field magnetic induction (NFMI) sensor (e.g., an NFMI transceiver coupled to a magnetic antenna) for effecting short-range communications (e.g., ear-to-ear communications, ear-to-kiosk communications). The communications device 208 may also include wired communications, e.g., universal serial bus (USB) and the like. Further, the communication devices 208 can include a flexible antenna disposed on or at least partially within a PCBA (e.g., PCBA 44) disposed within the enclosure 236.

The device 200 also includes a power source 242 (e.g., battery 42 of FIG. 6), which can be a conventional battery, a rechargeable battery (e.g., a lithium-ion battery), or a power source including a supercapacitor. In the embodiment shown in FIG. 11, the device 200 includes a rechargeable power source 242 that is operably coupled to power management circuitry for supplying power to various components of the device 200. The rechargeable power source 242 is coupled to charging circuitry 206. The charging circuitry 206 is, for example, electrically coupled to charging contacts on the enclosure 236 that are configured to electrically couple to corresponding charging contacts (e.g., charging contacts 78 of FIG. 4) of a charging unit when the device 200 is placed in the charging unit.

The device 200 can further include any other suitable electronic elements or components. Although not shown, the device 200 can include one or more inertial measurement units (IMUs) disposed within the enclosure 236. In one or more embodiments, such IMUs can be disposed on or at least partially within a PCBA (e.g., PCBA 44) that is disposed within the enclosure 236.

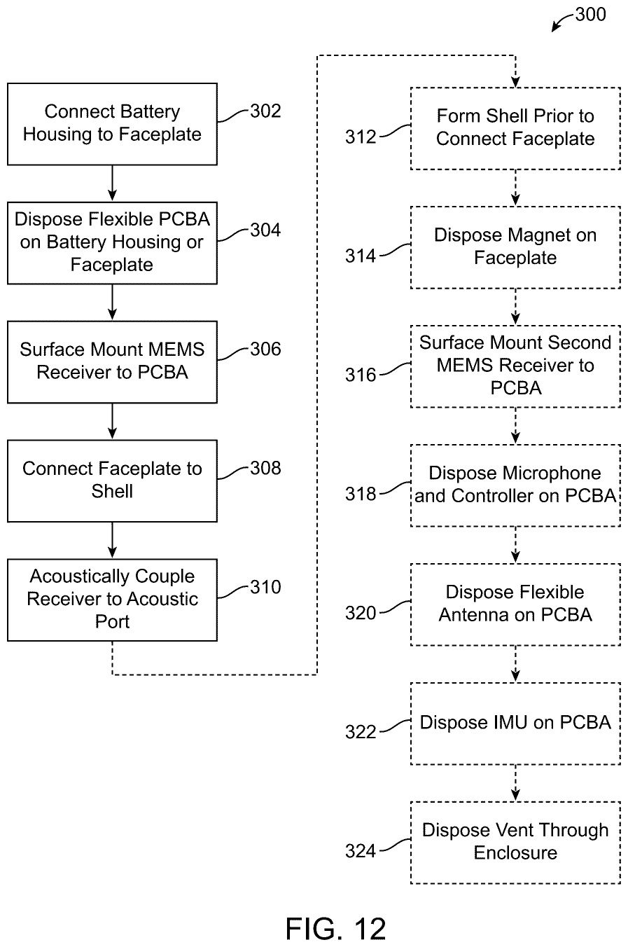

The various embodiments of ear-wearable electronic devices described herein can be manufactured utilizing any suitable technique. For example, FIG. 12 is a flowchart of one embodiment of a method 300 that can be utilized to manufacture ear-wearable hearing device 10 of FIGS. 1-9. Although described regarding device 10, the method 300 can be utilized to manufacture any suitable ear-wearable electronic device.

At 302, the electro-mechanical package 26 can be formed using any suitable technique. For example, the package 26 can be formed by connecting the battery housing 38 to the faceplate 28 using any suitable technique. The flexible PCBA 44 can be disposed on at least one of an exterior surface 46 of the battery housing 38 or the faceplate 28 at 304 using any suitable technique. At 306, the one or more MEMS receivers 48 can be surface mounted to the PCBA 44 using any suitable surface mounting technique either prior to or after the PCBA is disposed on one or both of the battery housing 38 or the faceplate 28. The faceplate 28 can be connected to the second end 20 of the shell 12 at 308 using any suitable technique, e.g., adhering, mechanically fastening, friction or press fitting, bonding, weld, etc. In one or more embodiments, the shell 12 includes the first contact surface 24 at the second end 20 of the shell, and the faceplate 28 includes the second contact surface 34, where connecting the faceplate to the shell includes matingly engaging the first contact surface of the second end of the shell with the second contact surface of the faceplate. Further, in one or more embodiments, the first contact surface 24 can interlockingly engage with the second contact surface 34 to connect the faceplate 28 to the shell 12.

The shell 12 and the faceplate 28 form the enclosure 36 within which the MEMS receiver 48 and the PCBA 44 are disposed. Further, the one or more MEMS receivers 48 are disposed proximate to the second end 20 of the shell 12 when the shell is connected to the faceplate 28.

At 310, the MEMS receiver 48 can be acoustically coupled to the inlet 52 of the acoustic port 50 that is disposed at least partially within the enclosure 36 using any suitable technique, where the acoustic port extends between the inlet and the outlet 54 that is disposed at the first end 16 of the shell 12 that is configured to be disposed in the ear canal 18 of the wearer.

At 312, the shell 12 can optionally be formed prior to connecting the faceplate 28 to the shell using any suitable technique, where the shell corresponds uniquely to an ear geometry of the ear 2 of the wearer. In one or more embodiments, the shell 12 can be formed by measuring the ear geometry of the ear 2 of the wearer using any suitable technique, and the shell can be molded using any suitable technique such that it corresponds uniquely to the ear geometry of the ear of the wearer.

At 314, the magnet 76 can optionally be disposed on or at least partially within the faceplate 28 using any suitable technique.

At 316, the optional second MEMS receiver 48-2 can be surface mounted to the PCBA 44 prior to connecting the faceplate 28 to the shell 12 using any suitable technique. Further the microphone (e.g., microphone arrangement 280 of FIG. 11) and a controller (e.g., processor 201 of FIG. 11) can be disposed on the PCBA 44 at 318 using any suitable technique prior to connecting the faceplate 28 to the shell 12. At 320, a flexible antenna can optionally be disposed on or at least partially within the PCBA 44 prior to connecting the faceplate 28 to the shell 12 using any suitable technique. Further, an inertial measurement unit (IMU) can be disposed on or at least partially within the PCBA 44 at 322 using any suitable technique prior to connecting the faceplate 28 to the shell 12. At 324, the vent 70 can optionally be disposed through the enclosure 36 using any suitable technique prior to connecting the faceplate 28 to the shell 12, where the vent extends between the faceplate 28 and the first end 16 of the shell.

It is understood that various embodiments described herein may be implemented with any custom ear-wearable electronic device without departing from the scope of this disclosure. The devices depicted in the figures are intended to demonstrate the subject matter, but not in a limited, exhaustive, or exclusive sense. Ear-wearable electronic devices, such as hearables (e.g., personal amplification devices, earbuds), hearing aids, and hearing assistance devices, include a custom shell within which internal components are disposed. Typical components of an ear-wearable electronic device can include a digital signal processor (DSP), a controller, other digital logic circuitry (e.g., ASICs, FPGAs), memory (e.g., ROM, RAM, SDRAM, NVRAM, EEPROM, and FLASH), power management circuitry (e.g., including charging circuitry), one or more communication devices (e.g., an RF radio, a near-field magnetic induction (NFMI) device), one or more antennas, one or more microphones, audio processing circuitry, and an acoustic transducer (e.g., receiver/speaker), for example. Some ear-wearable electronic devices can incorporate a long-range communication device, such as a Bluetooth® transceiver or other type of radio frequency (RF) transceiver. A communication device (e.g., a radio or NFMI device) of an ear-wearable electronic device can be configured to facilitate communication between a left ear device and a right ear device. These and other components can be supported by, or coupled to, the flexible PCBA of the device as previously discussed.

Some ear-wearable electronic devices can incorporate one or more sensors in addition to an IMU. For example, an ear-wearable electronic device can incorporate one or more of a temperature sensor, an optical PPG sensor (e.g., pulse oximeter), a physiologic electrode-based sensor (e.g., ECG, oxygen saturation (SpO2), respiration, EMG, EEG, EOG, galvanic skin response, electrodermal activity sensor), and a biochemical sensor (e.g., glucose concentration, PH value, Ca+ concentration, hydration). Embodiments disclosed herein can incorporate one or more of the sensors disclosed in commonly owned co-pending U.S. Patent Publication No. 2024/0007777 A1, entitled PHYSIOLOGIC SENSING PLATFORM FOR COOPERATIVE USE WITH AN EAR-WEARABLE ELECTRONIC DEVICE, and U.S. Patent Publication No. 2022/0190188 A1, entitled ELECTRO-OPTICAL PHYSIOLOGIC SENSOR.

The term ear-wearable electronic device of the present disclosure refers to a wide variety of ear-wearable electronic devices that can aid a person with impaired hearing. The term ear-wearable electronic device also refers to a wide variety of devices that can produce optimized, amplified or processed sound for persons with normal hearing. Ear-wearable electronic devices of the present disclosure include hearables (e.g., earbuds) and hearing aids (e.g., hearing instruments), for example. As previously discussed, ear-wearable electronic devices include, but are not limited to, ITE, ITC, CIC or IIC type hearing devices.

Embodiments of the disclosure are defined in the claims; however, herein there is provided a non-exhaustive listing of non-limiting examples. Any one or more of the features of these examples may be combined with any one or more features of another example, embodiment, or aspect described herein.
Example Ex1. An ear-wearable electronic device including a shell having an outer surface that corresponds to an ear geometry of an ear of a wearer of the device. The shell includes a first end configured to be disposed in an ear canal of the wearer and a second end configured to be disposed proximate to a concha of the ear of the wearer, where the second end includes a first contact surface. The device further includes an electro-mechanical package connected to the shell. The package includes a faceplate having an outer surface and an inner surface, where the inner surface includes a second contact surface configured to engage the first contact surface of the second end of the shell to form an enclosure with the shell; a battery housing including a battery compartment configured to receive a battery, where the battery housing is configured to be connected to the inner surface of the faceplate; and a flexible printed circuit board assembly (PCBA) disposed within the enclosure proximate to the second end of the shell and supported by at least one of an exterior surface of the battery housing or the faceplate. The package further includes a micro-mechanical systems (MEMS) receiver disposed proximate to the second end of the shell and surface mounted to the PCBA. The device further includes an acoustic port disposed at least partially within the enclosure and extending between an inlet that is acoustically coupled to the receiver and an outlet that is disposed at the first end of the shell.
Example Ex2. The device of Ex1, where the shell corresponds uniquely to the ear geometry of the ear of the wearer.
Example Ex3. The device of any one of Ex1-Ex2, where the second contact surface of the faceplate is configured to matingly engage with the first contact surface of the second end of the shell.
Example Ex4. The device of Ex3, where the second contact surface of the faceplate is configured to interlockingly engage with the first contact surface of the second end of the shell.
Example Ex5. The device of any one of Ex1-Ex4, where the battery housing further includes a shape that conforms to a shape of the battery compartment.
Example Ex6. The device of any one of Ex1-Ex5, further including a magnet disposed on or at least partially within the faceplate.
Example Ex7. The device of any one of Ex1-Ex6, where at least a portion of the receiver is disposed outside the ear canal and proximate to the concha.
Example Ex8. The device of any one of Ex1-Ex7, where the shell further includes a first portion adjacent the first end of the shell and a second portion adjacent the second end of the shell, where the receiver is disposed in the second portion.
Example Ex9. The device of Ex8, where a maximum cross-sectional area of the second portion is greater than a maximum cross-sectional area of the first portion.
Example Ex10. The device of any one of Ex1-Ex9, where the electro-mechanical package further includes a second MEMS receiver surface mounted to the PCBA.
Example Ex11. The device of any one of Ex1-Ex10, where the electro-mechanical package further includes a microphone and a controller disposed on or at least partially within the PCBA.
Example Ex12. The device of any one of Ex1-Ex11, where the electro-mechanical package further includes a flexible antenna disposed on or at least partially within the PCBA.
Example Ex13. The device of any one of Ex1-Ex12, where the electro-mechanical package further includes an inertial measurement unit (IMU) disposed on or at least partially within the PCBA.
Example Ex14. The device of any one of Ex1-Ex13, where a portion of the PCBA extends across at least one opposing flat side of the battery.
Example Ex15. The device of any one of Ex1-Ex14, further including a vent that extends through the enclosure between the faceplate and the first end of the shell.
Example Ex16. An electro-mechanical package for an ear-wearable electronic device, including a faceplate having an outer surface, an inner surface, and a second contact surface configured to engage a first contact surface of a shell to form an enclosure of the hearing device; a battery housing including a battery compartment configured to receive a battery, where the battery housing is configured to be connected to the inner surface of the faceplate; and a flexible printed circuit board assembly (PCBA) supported by at least one of an exterior surface of the battery housing or the faceplate. The package also includes a micro-mechanical systems (MEMS) receiver surface mounted to the PCBA.
Example Ex17. The package of Ex16, where the second contact surface of the faceplate is configured to matingly engage with the first contact surface of the second end of the shell.
Example Ex18. The package of Ex17, where the second contact surface of the faceplate is configured to interlockingly engage with the first contact surface of the second end of the shell.
Example Ex19. The package of any one of Ex16-Ex18, where the battery housing further includes a shape that conforms to a shape of the battery compartment;
Example Ex20. The package of any one of Ex16-Ex19, further including a magnet disposed on or at least partially within the faceplate.
Example Ex21. The package of any one of Ex16-Ex20, further including a second MEMS receiver surface mounted to the PCBA.
Example Ex22. The package of any one of Ex16-Ex21, further including a microphone and a controller disposed on or at least partially within the PCBA.
Example Ex23. The package of any one of Ex16-Ex22, further including a flexible antenna disposed on or at least partially within the PCBA.
Example Ex24. The package of any one of Ex16-Ex23, further including an inertial measurement unit (IMU) disposed on or at least partially within the PCBA.
Example Ex25. The package of any one of Ex16-Ex24, where a portion of the PCBA extends across at least one opposing flat side of the battery.
Example Ex26. A method including forming an electro-mechanical package, where forming the package includes connecting a battery housing to a faceplate, where the battery housing has a battery compartment configured to receive a battery; disposing a flexible printed circuit board assembly (PCBA) on at least one of an exterior surface of the battery housing or the faceplate; and surface mounting a micro-mechanical systems (MEMS) receiver to the PCBA. The method further includes connecting the faceplate to a second end of a shell that is configured to be disposed proximate to a concha of the ear of a wearer, where the shell and the faceplate form an enclosure within which the receiver and the PCBA are disposed, where the receiver is disposed proximate to the second end of the shell; and acoustically coupling the receiver to an inlet of an acoustic port that is disposed at least partially within the enclosure and extends between the inlet and an outlet that is disposed at a first end of the shell that is configured to be disposed in an ear canal of the wearer.
Example Ex27. The method of Ex26, further including forming the shell prior to connecting the faceplate to the shell, where the shell corresponds uniquely to an ear geometry of the ear of the wearer.
Example Ex28. The method of Ex27, where forming the shell includes measuring the ear geometry of the ear of the wearer; and molding the shell to correspond uniquely to the ear geometry of the ear of the wearer.
Example Ex29. The method of any one of Ex26-Ex28, where the shell includes a first contact surface at the second end of the shell and the faceplate includes a second contact surface, where connecting the faceplate to the shell includes matingly engaging the first contact surface of the second end of the shell with the second contact surface of the faceplate.
Example Ex30. The method of Ex29, where connecting the faceplate to the shell includes interlockingly engaging the first contact surface of the second end of the shell with the second contact surface of the faceplate.
Example Ex31. The method of any one of Ex26-Ex30, further including disposing a magnet on or at least partially within the faceplate.
Example Ex32. The method of any one of Ex26-Ex31, where the shell further includes a first portion adjacent the first end of the shell and a second portion adjacent the second end of the shell, where the receiver is disposed in the second portion.
Example Ex33. The method of Ex32, where a maximum cross-sectional area of the second portion is greater than a maximum cross-sectional area of the first portion.
Example Ex34. The method of any one of Ex26-Ex33, further including surface mounting a second MEMS receiver to the PCBA prior to connecting the faceplate to the shell.
Example Ex35. The method of any one of Ex26-Ex34, further including disposing a microphone and a controller on or at least partially within the PCBA prior to connecting the faceplate to the shell prior to connecting the faceplate to the shell.
Example Ex36. The method of any one of Ex26-Ex35, further including disposing a flexible antenna on or at least partially within the PCBA prior to connecting the faceplate to the shell.
Example Ex37. The method of any one of Ex26-Ex36, further including disposing an inertial measurement unit (IMU) on or at least partially within the PCBA prior to connecting the faceplate to the shell.
Example Ex38. The method of any one of Ex26-Ex37, further including disposing a vent through the enclosure prior to connecting the faceplate to the shell, wherein the vent extends between the faceplate and the first end of the shell.

All references and publications cited herein are expressly incorporated herein by reference in their entirety into this disclosure, except to the extent they may directly contradict this disclosure. Illustrative embodiments of this disclosure are discussed and reference has been made to possible variations within the scope of this disclosure. These and other variations and modifications in the disclosure will be apparent to those skilled in the art without departing from the scope of the disclosure, and it should be understood that this disclosure is not limited to the illustrative embodiments set forth herein. Accordingly, the disclosure is to be limited only by the claims provided below.

What is claimed is:

1. An ear-wearable electronic device, comprising:
a shell comprising an outer surface that corresponds to an ear geometry of an ear of a wearer of the device, the shell comprising a first end configured to be disposed in an ear canal of the wearer and a second end configured to be disposed proximate to a concha of the ear of the wearer, the second end comprising a first contact surface;
an electro-mechanical package connected to the shell, the package comprising:
a faceplate comprising an outer surface and an inner surface, wherein the inner surface comprises a second contact surface configured to engage the first contact surface of the second end of the shell to form an enclosure with the shell;
a battery housing comprising a battery compartment configured to receive a battery, wherein the battery housing is configured to be connected to the inner surface of the faceplate;
a flexible printed circuit board assembly (PCBA) disposed within the enclosure proximate to the second end of the shell and supported by at least one of an exterior surface of the battery housing or the faceplate; and
a micro-mechanical systems (MEMS) receiver disposed proximate to the second end of the shell and surface mounted to the PCBA; and
an acoustic port disposed at least partially within the enclosure and extending between an inlet that is acoustically coupled to the receiver and an outlet that is disposed at the first end of the shell.

2. The device of claim 1, wherein the MEMS receiver is disposed within a distance of about 10 mm from the inner surface of the faceplate as measured along a longitudinal axis of the device that is substantially orthogonal to a center point of the faceplate.

3. The device of claim 1, wherein the shell further comprises a first portion adjacent the first end of the shell and a second portion adjacent the second end of the shell, wherein the receiver is disposed in the second portion.

4. The device of claim 3, wherein a maximum cross-sectional area of the second portion is greater than a maximum cross-sectional area of the first portion.

5. The device of claim 1, wherein the electro-mechanical package further comprises a second MEMS receiver surface mounted to the PCBA.

6. The device of claim 1, wherein the electro-mechanical package further comprises a microphone and a controller disposed on or at least partially within the PCBA.

7. The device of claim 1, wherein the electro-mechanical package further comprises a flexible antenna disposed on or at least partially within the PCBA.

8. The device of claim 1, wherein the electro-mechanical package further comprises an inertial measurement unit (IMU) disposed on or at least partially within the PCBA.

9. An electro-mechanical package for an ear-wearable electronic device, comprising:
a faceplate comprising an outer surface, an inner surface, and a second contact surface configured to engage a first contact surface of a shell to form an enclosure of the hearing device;
a battery housing comprising a battery compartment configured to receive a battery, wherein the battery housing is configured to be connected to the inner surface of the faceplate;
a flexible printed circuit board assembly (PCBA) supported by at least one of an exterior surface of the battery housing or the faceplate; and
a micro-mechanical systems (MEMS) receiver surface mounted to the PCBA.

10. The package of claim 9, wherein the battery housing further comprises a shape that conforms to a shape of the battery compartment.

11. The package of claim 9, further comprising a magnet disposed on or at least partially within the faceplate.

12. The package of claim 9, further comprising a second MEMS receiver surface mounted to the PCBA.

13. The package of claim 9, further comprising a microphone and a controller disposed on or at least partially within the PCBA.

14. The package of claim 9, further comprising a flexible antenna disposed on or at least partially within the PCBA.

15. The package of claim 9, further comprising an inertial measurement unit (IMU) disposed on or at least partially within the PCBA.

16. The package of claim 9, wherein a portion of the PCBA extends across at least one opposing flat side of the battery.

17. A method comprising:
forming an electro-mechanical package, wherein forming the package comprises:
connecting a battery housing to a faceplate, wherein the battery housing comprises a battery compartment configured to receive a battery;
disposing a flexible printed circuit board assembly (PCBA) on at least one of an exterior surface of the battery housing or the faceplate; and
surface mounting a micro-mechanical systems (MEMS) receiver to the PCBA;
connecting the faceplate to a second end of a shell that is configured to be disposed proximate to a concha of the ear of a wearer, wherein the shell and the faceplate form an enclosure within which the receiver and the PCBA are disposed, wherein the receiver is disposed proximate to the second end of the shell; and
acoustically coupling the receiver to an inlet of an acoustic port that is disposed at least partially within the enclosure and extends between the inlet and an outlet that is disposed at a first end of the shell that is configured to be disposed in an ear canal of the wearer.

18. The method of claim 17, wherein the shell further comprises a first portion adjacent the first end of the shell and a second portion adjacent the second end of the shell, wherein the receiver is disposed in the second portion.

19. The method of claim 18, wherein a maximum cross-sectional area of the second portion is greater than a maximum cross-sectional area of the first portion.

20. The method of claim 17, further comprising surface mounting a second MEMS receiver to the PCBA prior to connecting the faceplate to the shell.
